(19) United States
(12) Patent Application Publication
(10) Pub. No.: US 2013/0284408 A1
(43) Pub. Date: Oct. 31, 2013

(54) Reservoir Cooling Apparaturs and Method

(71) Applicants: Douglas P. Miller, New Berlin, WI (US); Michael T. Landrum, Rockford, IL (US)

(72) Inventors: Douglas P. Miller, New Berlin, WI (US); Michael T. Landrum, Rockford, IL (US)

(73) Assignee: SPX CORPORATION, Charlotte, NC (US)

(21) Appl. No.: 13/460,526

(22) Filed: Apr. 30, 2012

(51) Int. Cl. F28D 15/00; B23P 15/26

(52) U.S. Cl. 165/104.34; 29/890.035

(57) ABSTRACT

A cooling reservoir may be provided. The cooling reservoir may include: a generally polygon shaped container having sides that define at least two corners; a fan configured to blow air across two sides that define one of the corners; and cooling fins attached to the sides. A method for making a cooling reservoir may be provided. The method may include: providing generally polygon shaped container having sides that define at least two corners; mounting a fan to blow air across two sides that define one of the corners; and attaching cooling fins to the sides.

### FIELD OF THE INVENTION

The present invention relates generally to a reservoir configured to cool the fluid contained in within the reservoir. More particularly, the present invention relates to a hydraulic fluid reservoir for a high pressure pump that is configured to cool the hydraulic fluid.

### BACKGROUND OF THE INVENTION

Many power tool systems include a fluid reservoir. Some of the power tool systems may impart heat to the fluid contained in the reservoir. It may be desirable to cool the fluid contained in the reservoir. For example, high pressure pumps are high performance pumps as well. Some high pressure pumps have the ability to generate extra work compared to other pumps of the same flow rates. If the tools attached to these pumps cannot use the extra work capacity, the result may be added heat to the system that is transferred to the hydraulic oil. If this heat is not controlled or dissipated, damage may occur to the pumping unit or to the tools attached to the pumping unit that may be used in the pressurized fluid.

Some current tools use a reservoir design that requires the heated fluid to flow through radiator type heat exchangers. Other tools may require heat exchangers that use separate water cooling lines to transfer heat from the fluid contained in the reservoir. These types of units may not always be practical with small portable pumping units.

Accordingly, it is desirable to provide a method and apparatus that may permit an efficient and lightweight apparatus that is capable of removing heat from the fluid contained within a reservoir.

### SUMMARY OF THE INVENTION

The foregoing needs are met, to a great extent, by the present invention, wherein in some embodiments an apparatus and method is provided that can efficiently remove heat from the fluid contained in the reservoir.

In accordance with one embodiment of the present invention, a cooling reservoir may be provided. The cooling reservoir may include: a generally polygon shaped container having sides that define at least two corners; a fan configured to blow air across two sides that define one of the corners; and cooling fins attached to the sides.

In accordance with another embodiment of the present invention, a method for making a cooling reservoir may be provided. The method may include: providing generally polygon shaped container having sides that define at least two corners; mounting a fan to blow air across two sides that define one of the corners; and attaching cooling fins to the sides.

In accordance with yet another embodiment of the present invention, a cooling reservoir is provided. The cooling reservoir may include: a means for containing a fluid, generally polygon shaped and having sides that define at least two corners; a means for moving air configured to blow air across two sides that define one of the corners; and a means for cooling attached to the sides.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a reservoir cooling system in accordance with an embodiment of the invention.

FIG. 2 is a top view of the reservoir cooling system illustrated in FIG. 1.

FIG. 3 is a top view of a hydraulic pump using a hydraulic reservoir cooling system in accordance with an embodiment of the invention.

FIG. 4 is a left side view of a hydraulic pump using a fluid cooling reservoir in accordance with an embodiment of the invention.

FIG. 5 is front view of a hydraulic pump using a reservoir cooling system in accordance with an embodiment of the invention.

FIG. 6 is a right side view of a hydraulic pump using a fluid cooling system in accordance with an embodiment of the invention.

### DETAILED DESCRIPTION

The invention will now be described with reference to the drawing figures, in which like reference numerals refer to like parts throughout. An embodiment in accordance with the present invention provides a method and apparatus that provides a transfer of heat energy which is integrated into the oil reservoir itself The location and shape of the reservoir and the location of the cooling fans assist in providing an efficient transfer of heat.

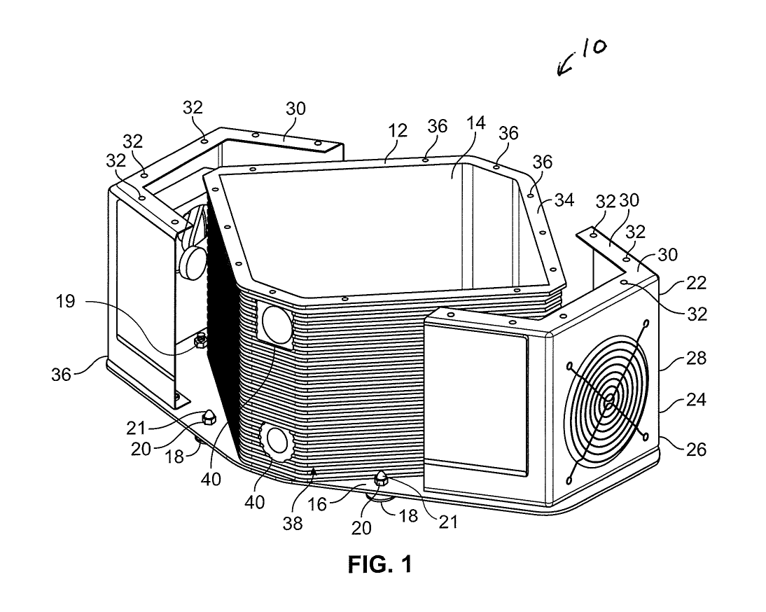

FIG. 1 illustrates a cooling reservoir 10 in accordance with an embodiment of the invention. The reservoir 12 may be made of extruded aluminum or any other suitable substance. The reservoir 12 is configured to contain a fluid such as, for example, a hydraulic fluid used in a high pressure pump. The fluid may be contained in the interior 14 of the reservoir 12.

The reservoir 12 is mounted to a base plate 16. The base plate 16 may be equipped with feet 18 so that the base plate 16 may be spaced from off the ground or whatever surface the cooling reservoir 10 is placed upon. The feet 18 may have feet fasteners 20 which can be adjustable to allow a user to adjust the feet 18 to whatever distance from the base plate 16 is desired. The feet fasteners 18 may include bolts 19 attached to the feet 18 and acorn nuts 21 as shown. In other embodiments of the invention, the feet fasteners 20 may simply be bolts that are screwed into threaded holes in the base plate 16.

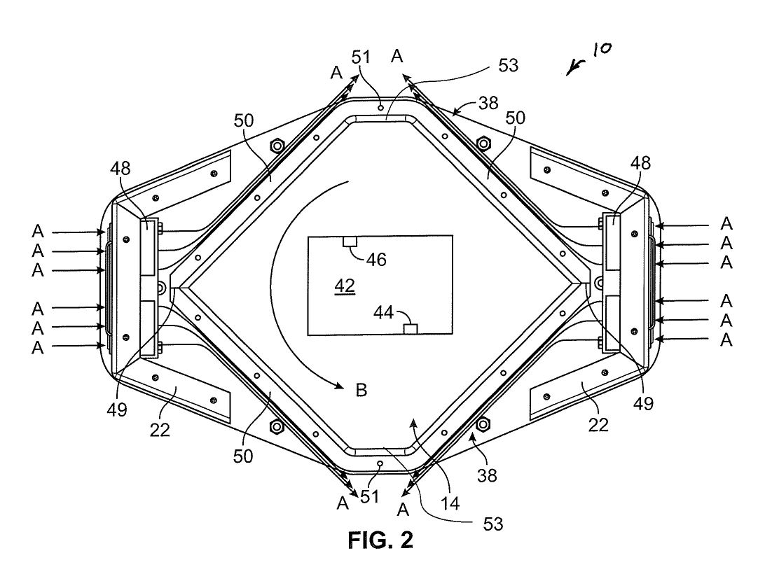

The reservoir 12 may have air shield 22 placed near the reservoir 12. The air shield 22 may be mounted to the base plate 16 as shown. The air shield 22 may be equipped with a grill 24 that is attached to the air shield 22 with fasteners 26. The grill 24 may provide a protective covering for a fan 28 contained and supported by the air shield 22. The air shield 22 contains the fan 28 and is configured to direct air blown by the fan 28 over the reservoir 12 as shown in FIG. 2. In some embodiments and as shown in the FIGS, the cooling reservoir 10 may be equipped with two cooling fans 28 and air shields 22.

In some embodiments of the invention, the reservoir 12 may include instrument holes 40.

The arrows A illustrated in FIG. 2 show air flowing through the fan 28 and across the reservoir 12. The shape of the air shield 22 may aid in directing the air across the reservoir 22.

Returning to FIG. 1, the air shield 22 may include a flattened portion 30 and fastener holes 32. The reservoir 12 may also include a flattened portion 34 and fastener holes 36.

The reservoir 12 may also include fins 38. Fins 38 may be attached to the reservoir 12 by an attaching system, fasteners, or may be attached to the reservoir 12 by virtue of being integrated and formed with the reservoir 12. For example, in the embodiment shown the reservoir 12 including the fins 38 are made of extruded aluminum and are integrated.

Returning to FIG. 2, the interior 14 of the reservoir 12 may include a pump 42. The pump 42 may include an inlet 44 and outlet 46 which may be submerged within the fluid contained within the interior 14 of reservoir 12. Operation of the pump 42 may cause circulation of the fluid as indicated by the arrow B contained within the interior 14 of the reservoir 12 as shown in FIG. 2. As the pump 42 operates, extra energy generated by the pump 42 and not used by a tool attached to the pump 42 may result in the fluid becoming heated. As the heated fluid circulates into through the interior of the reservoir 14 as indicated by the arrow B, the heated fluid will contact the walls 12. Heat will transfer into the fins 38 and be dissipated by the air flowing over the fins 38 as generated by the fans 28. The fan shroud 48 may assist in protecting the fan 28 and directing the air across the fins 38 and the side walls 50 of the reservoir 12.

As shown by the arrows A in FIG. 2, the air can be blown by the fans 28 across the side walls 50 of the reservoir 12 and through the fins 38 and then vented outwardly and away from the cooling reservoir 10.

The reservoir 12, having a generally polygon shape and exposing corners 49 of the polygon into the air flow as shown in FIG. 2 assist in allowing the air flow generated by the fans 28 to blow across the side walls 50 of the reservoir 12 and through the fins 38 and then away from the cooling reservoir 10. In this manner, corners 49 of the reservoir 12 which are defined by coming together of two of the side walls 50 of the reservoir 12 are placed in the air flow.

As shown in FIG. 2, the reservoir 12 generally has a square shape and is oriented so that two of the corners 49 are exposed to the air flow. As also shown, two of the other corners 51 may have flat sides 53 rather than coming to a point as to the other corners 49.

While the shape of the reservoir 12 is shown in FIGS. 1-2, is generally square (as seen in a top view), other polygonal shapes may also be used. For example, parallelograms, rectangles, diamonds and any other suitable shapes may also be used. Preferably, the shape of the reservoir 12 defines a corner 49 where two of the walls 50 come together so the air flow is forced to be directed one way or another across the corner 49 as shown in FIG. 2. The shape of the reservoir 12 allows the cooling air to flow both across the walls 50 and fins 38 of reservoir 12 picking up heat along the way and also then move away from cooling reservoir 10 once the cooling air has picked up heat from the reservoir 12. As shown in FIG. 2, some embodiments have two fans 28, air shields 22 and fan shrouds 48. The fans 28, air shields 22 and fan shrouds 48 are oriented to flow air across two corners 49 (one corner 49 for each fan 28, air shield 22 and for shroud 48 set). The fans 28, air shield 22 and fan shrouds 48 are oriented to blow air toward each other.

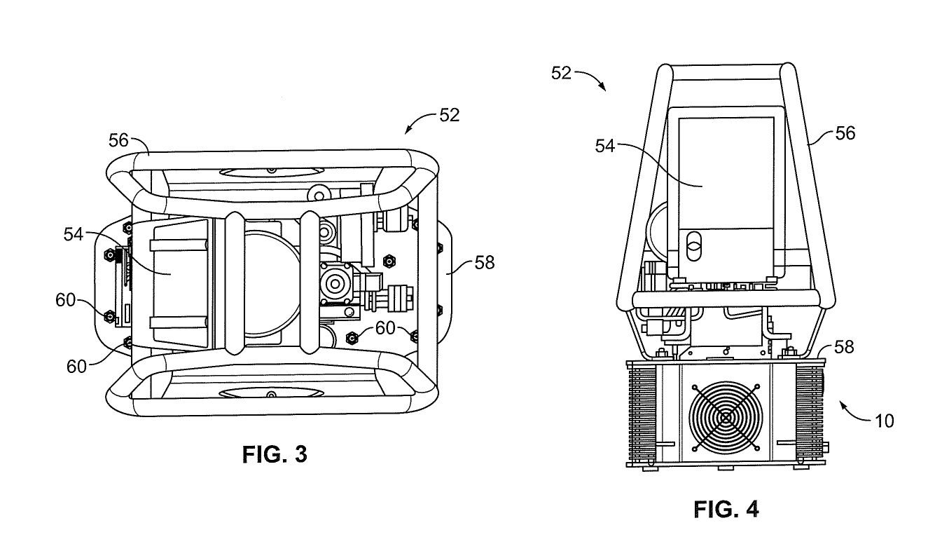

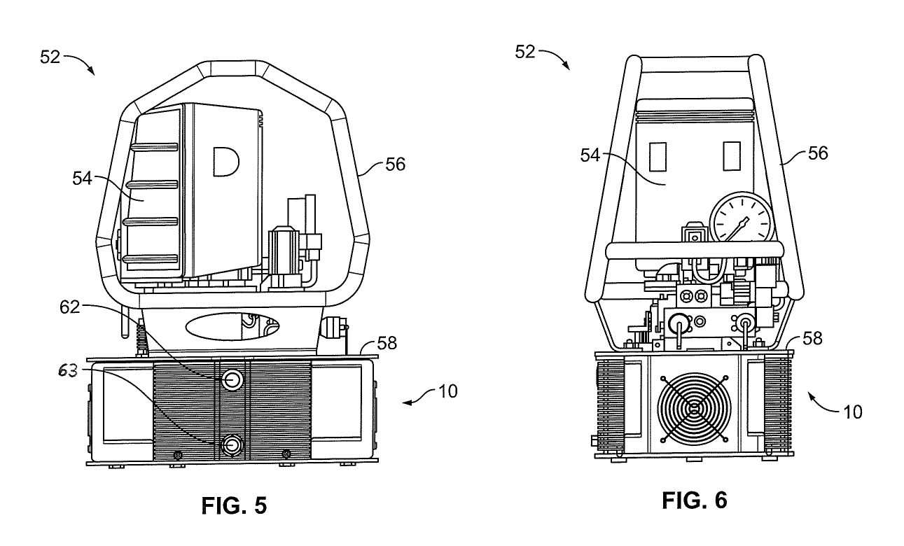

FIGS. 3-6 are top, left side, front and right side views respectively of a high pressure motor and pump assembly 52 attached to a hydraulic cooling reservoir 10 in accordance with an embodiment of the invention. The following description will be made with respect to FIGS. 3-6. FIGS. 3-6 illustrate a motor and pump assembly 52 which include a motor 54 protected by a roll bar assembly 56. The motor 54 is mounted onto the top of the top plate 58. The top plate 58 fits onto the flattened portions 30 and 54 of the reservoir 12 and air shield 22 (shown in FIGS. 1 and 2). The top plate 58 attaches via fasteners 60 into the fastener holes 32 and 36 (shown in FIGS. 1 and 2). The top plate 58 may be made of aluminum, steel, stainless steel or any other suitable substance.

Below the top plate 58 is the cooling reservoir 10 also shown and described with respect to FIGS. 1 and 2. A sight gauge 62 is illustrated and mounted within one of the instrument holes 40 shown in FIG. 1. The sight gauge 62 may be useful to allow an operator to look through the sight gauge 62 to view how much fluid is in the reservoir 12. The other hole 40 contains a drain plug 63 which is removable and allows a user to drain the reservoir 10 by removing the drain plug 63.

In some embodiments of the invention, the motor and pump assembly 52 may be electrically operated. In such embodiments, the fans 28 may also be electrically operated. In other embodiments of the invention, the motor and pump assembly 52 may be operated by compressed air and attached to separate air compressor. In such embodiments, the fan 28 may also be operated by compressed air or in other embodiments may be electrically operated where electric power is either provided or generated by compressed air. Also, exhausting compressed air from an Air Motor that runs the pump or other device may be directed towards the corners of the reservoir in a similar manor as the fans are directing air to flow.

The fan 28 may be controlled by a controller that may be integrated with or separate from controller that operates the motor and pump assembly 52. In some embodiments of the invention, the motor and pump assembly 52 may be any standard or suitable motor and pump assembly 57 that can be fitted to a cooling reservoir 10 in accordance with an embodiment of the invention.

One of the advantages of the cooling reservoir 10 in accordance with the invention is that it may be modified or designed to be compatible with known motor and pump assembly 52. One of ordinary skill in the art, after reviewing this disclosure, will understand how to adapt or modify a cooling reservoir 10 in accordance with this invention to a motor and pump assembly 52.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

what is claimed is:

1. A cooling reservoir comprising:
a generally polygon shaped container having sides that define at least two corners;
a fan configured to blow air across two sides that define one of the corners; and
cooling fins attached to the sides.

2. The reservoir of claim 1, further comprising a fan shield configured to direct air moved by the fan along the two sides that define of the corners.

3. The reservoir of claim 2, further comprising a bottom plate on which the container and the fan shield is mounted.

4. The reservoir of claim 3, further comprising feet attached to the bottom plate.

5. The reservoir of claim 1, wherein the container is generally square shaped.

6. The reservoir of claim 5, wherein the generally square shaped container has flat sections at locations in lieu of corners of the square shaped container and the flat sections are across from each other.

7. The reservoir of claim 1, further comprising a second fan configured to blow air across two sides that define one of the other corners.

8. The reservoir of claim 7, wherein the two fans are located opposite each other and are configured to blow air toward each other.

9. The reservoir of claim 1, wherein the container is extruded aluminum.

10. The reservoir of claim 1, wherein the container is configured to contain hydraulic fluid.

11. The reservoir of claim 1, further comprising a top plate connected to a top portion of the container.

12. The reservoir of claim 11, further comprising a fan shield and the fan shield is connected to the top plate.

13. The reservoir of claim 11, wherein the top plate covers the container.

14. The reservoir of claim 13, further comprising a pump located in the container and under the top plate.

15. The reservoir of claim 1, further comprising a pump located in the container.

16. The reservoir of claim 14, further comprising a motor operatively connected to the pump.

17. The reservoir of claim 18, further comprising a roll cage located round the motor and configured to protect the motor.

18. The reservoir of claim 1, further comprising a shroud configured to direct air blown by the fan.

19. A method for making a cooling reservoir comprising:
providing generally polygon shaped container having sides that define at least two corners;
mounting a fan to blow air across two sides that define one of the corners; and
attaching cooling fins to the sides.

20. A cooling reservoir comprising:
a means for containing a fluid, generally polygon shaped and having sides that define at least two corners;
a means for moving air configured to blow air across two sides that define one of the corners; and
a means for cooling attached to the sides.
